(19) United States
(12) Patent Application Publication
(10) Pub. No.: US 2022/0123399 A1
(43) Pub. Date: Apr. 21, 2022

(54) BATTERY MODULE FOR VEHICLE

(71) Applicants: HYUNDAI MOTOR COMPANY, Seoul (KR); KIA MOTORS CORPORATION, Seoul (KR)

(72) Inventor: Kyung Mo KIM, Hwaseong-si (KR)

(73) Assignees: HYUNDAI MOTOR COMPANY, Seoul (KR); KIA MOTORS CORPORATION, Seoul (KR)

(21) Appl. No.: 17/155,379

(22) Filed: Jan. 22, 2021

(30) Foreign Application Priority Data
Oct. 15, 2020 (KR) 10-2020-0133682

(51) Int. Cl. H01M 50/204; H01M 50/502; H01M 10/04

(52) U.S. Cl. CPC H01M 50/204; H01M 2220/20; H01M 10/0413; H01M 50/502

(57) ABSTRACT

A battery module for a vehicle is constituted by coupling two end plates (21) and two sensing blocks (22) such that the end plates (21) and the sensing blocks (22) are integrally formed to constitute one module type component (20) and coupling the integrated one module type component (20) to battery cells (10), which are stacked, such that the one module type component (20) surround peripheries of the battery cells (10).

### CROSS REFERENCE TO RELATED APPLICATION

This application claims priority to Korean Patent Application No. 10-2020-0133682, filed on Oct. 15, 2020, the entire contents of which are incorporated herein by reference.

### FIELD

The present disclosure relates to a battery module for a vehicle.

### BACKGROUND

The statements in this section merely provide background information related to the present disclosure and may not constitute prior art.

Hybrid electric cars, fuel cell cars, electric cars, and environmentally-friendly cars are all configured to use electric motors to be driven, and thus are necessarily equipped with high-voltage battery packs for providing driving power to the electric motors.

A high-voltage battery pack commonly includes a battery case, multiple battery modules mounted inside the battery case, and a battery management system (BMS) for sensing the voltage, current, temperature, and the like of respective unit cells constituting the battery modules and controlling operations thereof.

In addition, each battery module includes multiple battery cells stacked on each other, left/right end plates coupled to the left/right sides of the stacked battery cells so as to protect the battery cells, and front/rear sensing blocks coupled to the front/rear sides of the stacked battery cells so as to electrically connect the battery cells to each other.

However, we have discovered that conventional battery modules have drawbacks in that the two left/right end plates and the two front/rear sensing blocks are individual components separate from each other such that, when a pouch-type cell and these four components are assembled to each other to constitute a battery module, it is difficult to position the end plates and the sensing blocks, thereby inconveniencing the assembly process, and if a separate assembly jig is used to solve this problem, the cost is increased.

In addition, conventional battery modules have another drawback in that the end plates and the sensing blocks need to be assembled in separate processes, and the increased assembly process lines accordingly increase costs and degrade productivity.

The above descriptions regarding background arts are only for helping understanding of the background of the present disclosure, and are not to be considered by a person skilled in the art as corresponding to already-known prior arts.

### SUMMARY

An aspect of the present disclosure is to provide a battery module including a battery cell, two end plates, and two sensing blocks, which are modularized such that the end plates and the sensing blocks constitute a single component before being assembled with the battery cell, thereby shortening the battery module assembly line, reducing the number of assembly processes, and thus accomplishing cost reduction and productivity improvement.

In one form of the present disclosure, a battery module for a vehicle includes: a pair of end plates and a pair of sensing blocks; a coupling mechanism configured to connect the pair of end plates to the pair of sensing blocks so as to form one module type component by connecting and coupling the end plates and the sensing blocks. The module type component may be coupled to battery cells, which are stacked, to surround peripheries of the battery cells.

The module type component may be configured such that the end plates and the sensing blocks are connected to each other in a rectangular shape by connecting and coupling corners of the end plates and corners of the sensing blocks with the coupling mechanism in a state in which the end plates are disposed to face each other and the sensing blocks are disposed to face each other.

The coupling mechanism may include: hinge brackets fixedly coupled to opposite ends of the end plates; first coupling pins fixedly coupled to the hinge brackets, respectively; second coupling pins fixedly coupled to opposite ends of the sensing blocks, respectively; and link brackets coupled to connect the first coupling pins and the second coupling pins.

Each of the first coupling pins and the second coupling pins may include: a rod part fixed to the hinge bracket and the sensing block; and a head part having a cross-sectional diameter that is larger than a cross-sectional diameter of the rod part. The link brackets may be coupled to connect the first coupling pins and the second coupling pins while the rod parts pass through the link brackets.

A coupling hole, through which the rod part passes, may be formed in each of the link brackets to extend along a lengthwise direction of the link bracket, and an assembly hole, into which the head part is inserted, may be formed at one end of the coupling hole.

The rod parts of the first coupling pins may be located at ends of the coupling holes after the head parts of the first coupling pins pass through the assembly holes of the link brackets. The connected pair of end plates and sensing blocks form the one module type component, which is integrally formed, by passing the head parts of the second coupling pins through the assembly holes of the link brackets and connecting and coupling the end plates and the sensing blocks through the link brackets. The battery cells, which overlap each other, and the module type component may be coupled to each other by moving the sensing blocks such that the rod parts of the second coupling pins are located in the coupling holes after the battery cells are located in the module type component.

The exemplary forms of the present disclosure are advantageous in that two end plates and two sensing blocks are coupled and integrated by a coupling mechanism, thereby constituting a constituting one module-type component, and the single integrated module-type component is coupled to stacked battery cells so as to surround the periphery of the battery cells, thereby constituting a battery module. As a result, the battery module assembly operation proceeds conveniently, thereby substantially improving the operation convenience. Particularly, the module-type component can be assembled to battery cells in a single assembly line so as to constitute a battery module, thereby shortening the assembly line and reducing the number of assembly processes. Consequently, cost reduction and production improvement can be accomplished.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a plan view of a battery module constituted by coupling a module type component and battery cells according to one form of the present disclosure;

FIG. 2 is an exploded perspective view of the module type component and the battery cells according to one form of the present disclosure;

FIGS. 3 and 4 are views illustrating a coupling mechanism according to another form of the present disclosure;

FIGS. 5A, 5B, 5C, 5D and 5E illustrate views for explaining a process of assembling the module type component according to one form of the present disclosure; and

FIGS. 6A, 6B, 6C and 6D illustrate views for explaining a process of assembling the battery module by coupling the module type component and the battery cells according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A specific structural or functional description of exemplary forms of the present disclosure disclosed in the specification or application is given merely for the purpose of describing the form according to the present disclosure. Therefore, the forms according to the present disclosure may be implemented in various forms, and the present disclosure should not be construed as being limited to the forms described in the specification or application.

Various changes and modifications may be made to the forms according to the present disclosure, and therefore particular forms will be illustrated in the drawings and described in the specification or application. However, it should be understood that forms according to the concept of the present disclosure are not limited to the particular disclosed forms, but the present disclosure includes all modifications, equivalents, and alternatives falling within the spirit and scope of the present disclosure.

Such terms as “a first” and/or “a second” may be used to described various elements, but the elements should not be limited by these terms. These terms are intended merely to distinguish one element from other elements. For example, a first element may be named a second element and similarly a second element may be named a second element without departing from the scope of protection of the present disclosure.

In the case where an element is referred to as being “connected” or “accessed” to other elements, it should be understood that not only the element is directly connected or accessed to the other elements, but also another element may exist between them. Contrarily, in the case where a component is referred to as being “directly connected” or “directly accessed” to any other component, it should be understood that there is no component therebetween. The other expressions of describing a relation between structural elements, i.e. “between” and “merely between” or “neighboring” and “directly neighboring”, should be interpreted similarly to the above description.

The terms used in the present disclosure are merely used to describe specific forms, and are not intended to limit the present disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure.

A control unit (controller) according to exemplary forms of the present disclosure may be implemented by a non-volatile memory (not shown) which is configured to store data pertaining to an algorithm configured to control operations of various vehicle components or software instructions for reproducing the algorithm, and a processor (not shown) which is configured to perform the operations as described below by using the data stored in the corresponding memory. Here, the memory and the processor may be implemented as individual chips. Alternatively, the memory and the processor may be implemented as an integrated single chip. The processor may be in the form of one or more processors.

Hereinafter, a battery module for a vehicle according to one form of the present disclosure will be described with reference to the accompanying drawings.

A vehicle that uses an electric motor as a driving source is provided with a high-voltage battery pack that provides driving electric power to the electric motor.

A high-voltage battery pack generally includes a battery case, a plurality of battery modules mounted in the battery case, and a battery management system (BMS) that detects the voltages, the currents, the temperatures, and the like of respective unit cells constituting the battery modules and controls the operations of the unit cells.

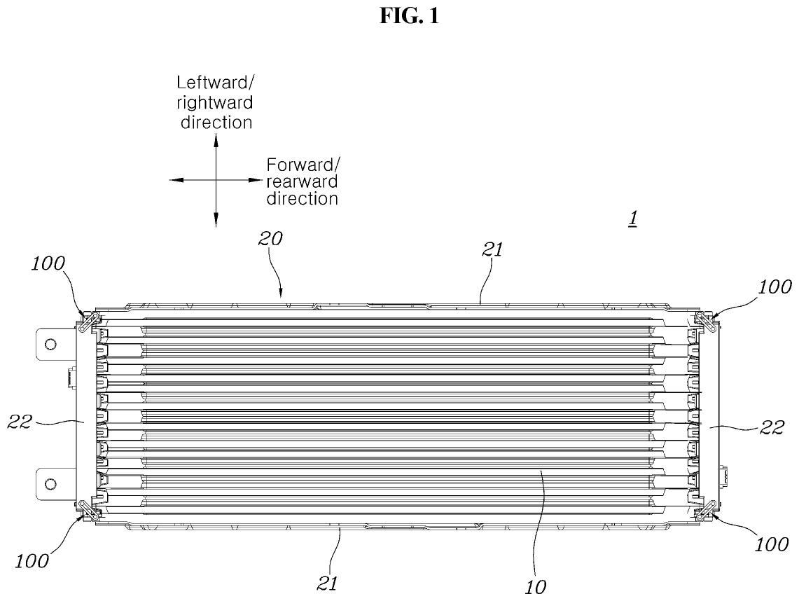

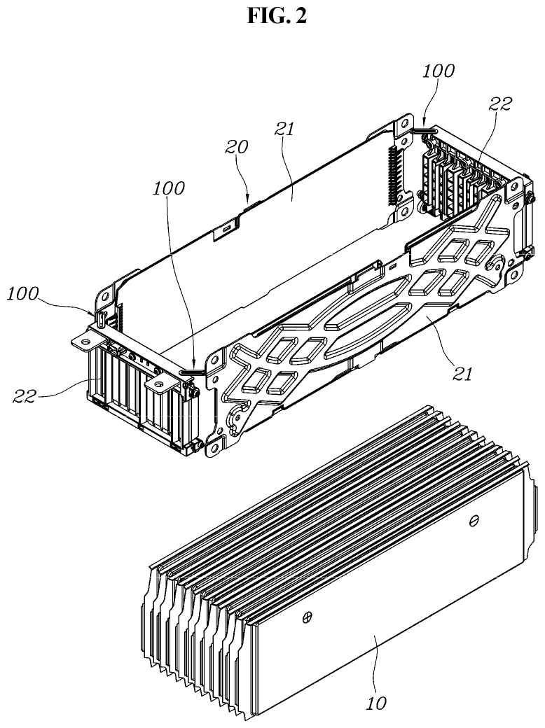

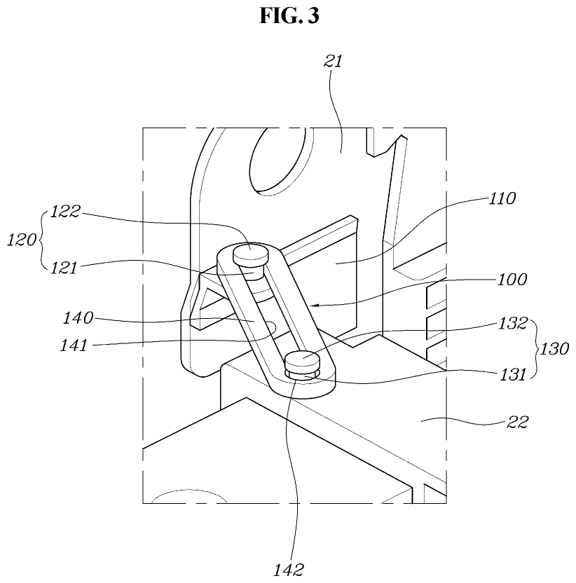

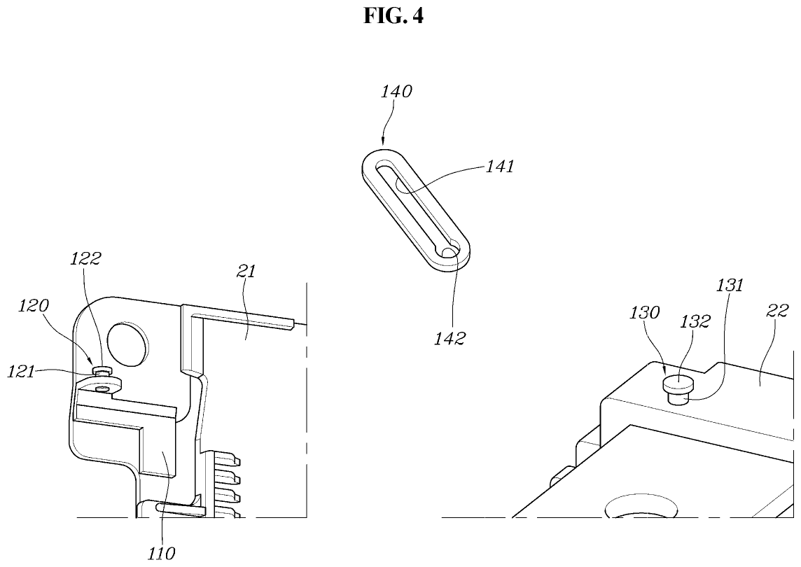

As illustrated in FIGS. 1 to 6, a battery module 1 according to exemplary forms of the present disclosure includes: a plurality of battery cells 10, which are stacked, and one module type component 20 coupled to the battery cells 10 to surround peripheries of the battery cells 10.

The module type component 20 refers to one component in which a pair of end plates 21 and a pair of sensing blocks 22 are connected to each other through a coupling mechanism 100 to be integrally formed.

Two end plates 21 are disposed on the left and right sides to face each other while the stacked battery cells 10 are interposed therebetween, and are formed of rigid bodies to protect the battery cells 10 and control repulsive forces against swelling of the cells.

Two sensing blocks 22 are disposed on the front and rear sides to face each other while the stacked battery cells 10 are interposed therebetween to electrically connect the battery cells 10.

The battery module 1 constitutes one module type component 20 by coupling two end plates 21 and two sensing blocks 22 with a plurality of coupling mechanisms 100 such that the end plates 21 and the sensing blocks 22 are integrally formed and the integrated one module type component 20 is coupled to the battery cells 10 to surround peripheries of the stacked battery cells 10, and through this, the number of assembly lines and the number of processes of assembling the battery module 1 can be reduced, and as a result, costs can be reduced and productivity can be improved.

A conventional battery module has a structure in which two end plates and two sensing blocks are individually separated, and it is difficult to regulate the locations of the end plates and the sensing blocks, making it inconvenient to assemble them when pouch type cells and the four components are assembled to constitute the battery module, and costs increase when a separate assembly jig is used to solve the problem, and in particular, because the end plates and the sensing blocks have to be assembled in separate processes, costs are high and productivity is low due to an increase of the assembly process lines.

In contrast, according to the forms of the present disclosure, two end plates 21 and two sensing blocks 22 are coupled to each other to be integrally formed by the coupling mechanisms 100 to constitute one module type component 20 and the integrated one module type component 20 is coupled to the battery cells 10 to surround the peripheries of the stacked battery cells 10 so as to constitute the battery module 1, and as compared with the conventional technology, the operation of assembling the battery module 1 is very easy, significantly improving the convenience of the operation, and in particular, the end plates 21 and the sensing blocks 22 can be assembled on one assembly line, whereby the number of assembly lines and the number of assembly processes can be reduced, and through this, costs can be reduced and productivity can be improved.

The module type component 20 is configured such that the end plates 21 and the sensing blocks 22 are connected to each other in a rectangular shape by connecting and coupling corners of the end plates 21 and corners of the sensing blocks 22 with the coupling mechanisms 100 in a state in which the end plates 21 are disposed to face each other and the sensing blocks 22 are disposed to face each other.

The coupling mechanisms 100 includes hinge brackets 110 fixedly coupled to opposite ends (opposite ends disposed to face the forward and rearward directions) of the end plates 21, first coupling pins 120 fixedly coupled to the respective hinge brackets 110, second coupling pins 130 fixedly coupled to opposite ends of the respective sensing blocks 22, and link brackets 140 coupled to connect the first coupling pins 120 and the second coupling pins 130.

Each of the first coupling pins 120 includes a rod part 121 fixed to the hinge bracket 110 and protruding from the hinge bracket 110, and a head part 122 integrally formed with an end of the rod part 121 and having a cross-sectional diameter that is larger than that of the rod part 121.

Each of the second coupling pins 130 includes a rod part 131 fixed to the sensing blocks 22 and protruding from the sensing blocks 22, and a head part 132 integrally formed with an end of the rod part 131 and having a cross-sectional diameter that is larger than that of the rod part 131.

The link bracket 140 is a steel bracket extending in a straight line while having a predetermined thickness, and has a structure in which the first coupling pin 120 and the second coupling pin 130 are connected and coupled to each other while passing through the rod parts 121 and 131 of the first and second coupling pins 120 and 130.

A coupling hole 141, through which the rod parts 121 and 131 of the first and second coupling pins 120 and 130 pass, is formed in the link bracket 140 to extend along a lengthwise direction of the link bracket 140, and an assembly hole 142, into which the head parts 122 and 132 of the first and second coupling pins 120 and 130 are inserted, is formed at one end of the coupling hole 141.

That is, the diameter of the assembly hole 142 is larger than the diameter of the coupling hole 141 formed in the link bracket 140, and the coupling hole 141 is a slit hole extending along the lengthwise direction of the link bracket 140.

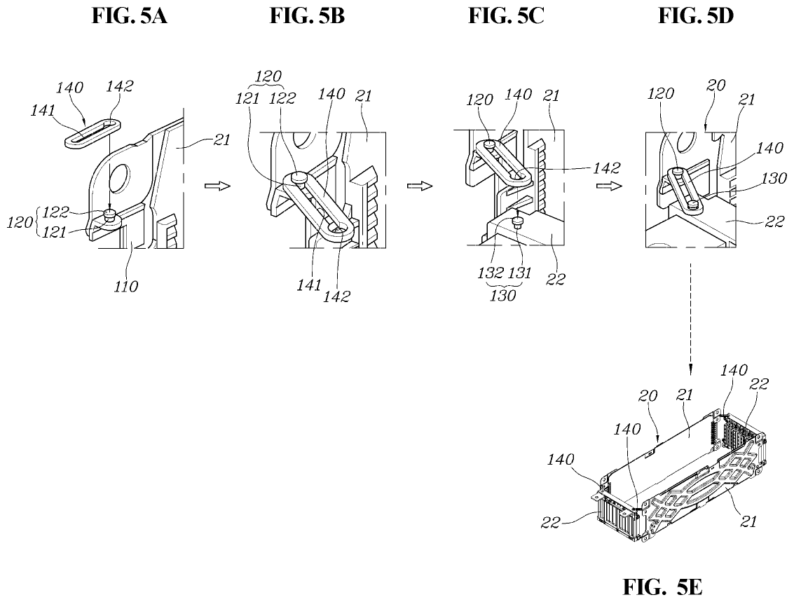

FIGS. 5A-5E illustrate an assembly process in which the two end plates 21 and the two sensing blocks 22 are coupled to each other to be integrally formed by the coupling mechanisms 100 so as to constitute one module type component 20.

After the link bracket 140 is located above the first coupling pin 120 as illustrated in FIG. 5A, the head part 122 of the first coupling pin 120 passes through the assembly hole 142 of the link bracket 140 as illustrated in FIG. 5B, and the link bracket 140 is moved such that the rod part 121 of the first coupling pin 120 is located at an end of the coupling hole 141 of the link bracket 140.

Next, if the head part 132 of the second coupling pin 130 passes through the assembly hole 142 of the link bracket 140 as illustrated in FIG. 5C, the end plate 21 and the sensing block 22 are connected and coupled to each other through the link bracket 140 as illustrated in FIG. 5D to completely constitute an integrated one module type component 20 in FIG. 5E.

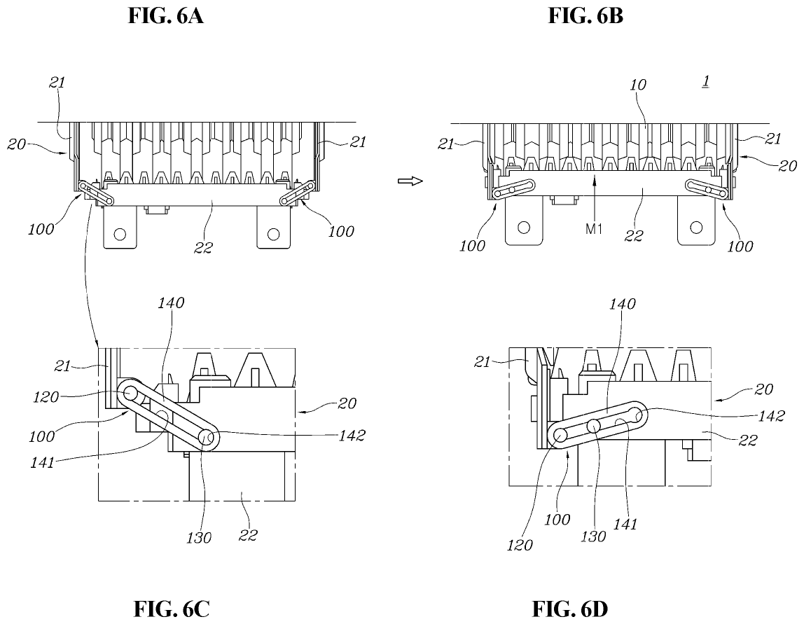

FIG. 6 illustrates a process of assembling a battery module 1 by coupling battery cells 10 and one module type component 20.

The integrated one module type component 20 is completely constituted by connecting and coupling the end plate 21 and the sensing block 22 through the link bracket 140 as illustrated in FIG. 5D, the overlapping battery cells 10 in the module type component 20 are located as illustrated in FIG. 6A, and then the sensing block 22 is pushed in a direction that faces the battery cells 10 as illustrated in FIG. 6B. Then, the second coupling pin 130, which has been located in the assembly hole 142 of the link bracket 140 as shown in FIG. 6C, is re-located at a site in the coupling hole 141 (see FIG. 6D) in a state in which the first coupling pin 120 is located at an end of the coupling hole 141 of the link bracket 140, and as the sensing block 22 is moved toward the battery cells 10 due to the rotation of the link bracket 140, the battery module 1 in which the battery cells 10 and the module type component 20 are coupled to each other is completely constructed.

As described above, two end plates 21 and two sensing blocks 22 are coupled to each other to be integrally formed by the coupling mechanisms 100 to constitute one module type component 20 and the integrated one module type component 20 is coupled to the battery cells 10 to surround the peripheries of the stacked battery cells 10 so as to constitute the battery module 1, and as compared with the conventional technology, the operation of assembling the battery module 1 is performed conveniently, significantly improving the convenience of the operation, and in particular, the end plates 21 and the sensing blocks 22 can be assembled on one assembly line to construct a battery module 1, whereby the number of assembly lines and the number of assembly processes can be reduced, and through this, costs can be reduced and productivity can be improved.

Although the present disclosure has been described and illustrated in conjunction with particular forms thereof, it will be apparent to those skilled in the art that various improvements and modifications may be made to the present disclosure without departing from the technical idea of the present disclosure.

What is claimed is:

1. A battery module for a vehicle, comprising:
a pair of end plates and a pair of sensing blocks; and
a coupling mechanism configured to connect the pair of end plates to the pair of sensing blocks so as to form one module,
wherein the one module formed with the connected pair of end plates and sensing blocks is coupled to and surrounds peripheries of battery cells which are stacked on one another.

2. The battery module of claim 1, wherein the pair of end plates and the pair of sensing blocks are connected to each other in a rectangular shape by connecting corners of the pair of end plates and corners of the pair of sensing blocks with the coupling mechanism in a state in which the pair of end plates are disposed to face to each other and the pair of sensing blocks are disposed to face to each other.

3. The battery module of claim 1, wherein the coupling mechanism comprises:
hinge brackets fixedly coupled to opposite ends of each end plate of the pair of end plates;
first coupling pins fixedly coupled to the hinge brackets, respectively;
second coupling pins fixedly coupled to opposite ends of each sensing block of the pair of sensing blocks; and
link brackets configured to connect the first coupling pins and the second coupling pins, respectively.

4. The battery module of claim 3, wherein each of the first coupling pins and the second coupling pins comprises:
a rod part fixed to a hinge bracket among the hinge brackets and a sensing block among the pair of sensing blocks; and
a head part having a cross-sectional diameter that is larger than a cross-sectional diameter of the rod part, and
wherein the link brackets are coupled to the first coupling pins and the second coupling pins while the rod parts pass through the link brackets.

5. The battery module of claim 4, wherein the rod part is configured to pass through a coupling hole formed in each of the link brackets to extend along a lengthwise direction of the link bracket, and
the head part is inserted into an assembly hole formed at one end of the coupling hole.

6. The battery module of claim 5, wherein the rod parts of the first coupling pins are located at ends of the coupling holes after the head parts of the first coupling pins pass through the assembly holes of the link brackets,
wherein the connected pair of end plates and sensing blocks is configured to form the one module by passing the head parts of the second coupling pins through the assembly holes of the link brackets and connecting the pair of end plates and the pair of sensing blocks through the link brackets, and
wherein the stacked battery cells and the one module are coupled to each other by moving the pair of sensing blocks such that the rod parts of the second coupling pins are located in the coupling holes after the stacked battery cells are located in the one module.
